(19) United States
(12) Patent Application Publication
(10) Pub. No.: US 2009/0210229 A1
(43) Pub. Date: Aug. 20, 2009

(54) Processing Received Voice Messages

(75) Inventors: Brian Scott Amento, Morris Plains, NJ (US); Christopher Harrison, Mount Kisco, NY (US); Larry Stead, Upper Montclair, NJ (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/032,974

(22) Filed: Feb. 18, 2008

(51) Int. Cl. G10L 15/04

(52) U.S. Cl. 704/251; 704/E15.001

(57) ABSTRACT

A voice message processing system shortens received voice messages to reduce the time a user must spend in reviewing the user's voice messages. In some embodiments, a data file associated with a caller is created and updated with words and associated audio files that may be used to replace longer words or phrases in future voice messages from the caller. A user may manually configure preferences to aggressively shorten messages in some embodiments. A speech synthesizer may be employed to replace text in messages when sufficient audio files are not stored to provide sufficient processing of messages. An audible indicator may be played with a revised message to allow a user to play back at least a portion of the original, received message without the substituted portions. Such systems provide a user the opportunity to review messages in a reduced time.

### BACKGROUND

1. Field of the Disclosure

The present disclosure generally relates to telephone message systems and more particularly to processing received messages to result in shorter messages.

2. Description of the Related Art

Voice message systems allow callers to leave a message if a telephone call is unanswered. In some cases, voice message systems limit the amount of time a caller may use to leave a message. For example, a voice message system may provide an audible beep to a caller and stop recording after one minute. In addition, voice message systems may indicate to a user that his or her “voicemail box” is full. Such systems limit the amount of time a user may take to review recorded voice messages.

### BRIEF DESCRIPTION OF THE DRAWINGS

FIG. 1 illustrates an environment in which disclosed embodiments may operate to shorten received voice messages;

FIG. 2 illustrates a computer readable media with selected modules that operate to process received voice messages in accordance with disclosed embodiments;

FIG. 3 depicts a data processing system for use with disclosed embodiments; and

FIG. 4 illustrates selected operations of a disclosed methodology for processing received voice messages.

### DESCRIPTION OF THE EMBODIMENT(S)

In one aspect, a method is disclosed for processing received voice messages. The method includes recognizing a word from a received voice message to result in a recognized word. The method further includes automatically substituting a stored word for the recognized word to result in a revised voice message. In some embodiments, the method further comprises determining a synonym for the recognized word wherein the synonym is the stored word for substituting for the recognized word. The method further includes playing the revised voice message with the synonym to result in the revised voice message being shorter than the received voice message. In some embodiments, the method includes comparing the recognized word to a plurality of known words. If the recognized word corresponds to a known word, the method may further include storing a voice file for the word. The method may further include associating the received voice message with a caller. In addition, the method may include establishing a voiceprint for the caller and comparing the voiceprint of the caller with stored voice prints to determine the identity of the caller.

In another aspect, a computer program product stored on one or more computer readable media is disclosed. The computer program product has instructions operable for recognizing a word from a received voice message to result in a recognized word. The computer program product further has instructions operable for substituting a stored word for the recognized word to result in a revised voice message. Further instructions may be operable for building the revised voice message by inserting a stored sound file in place of the recognized word, wherein the stored sound file is associated with the stored word. Further instructions may be operable for playing the revised voice message and providing an audible signal to indicate when the stored sound file is played within the revised voice message. Additional instructions may be operable for repeating a portion of the revised message in response to user input to result in playing a repeated portion of the voice message. The repeated portion contains the recognized word in place of the stored sound file.

In an additional aspect, a voice message system is disclosed that includes an identification module for identifying a caller. The caller produces speech output to result in a received voice message. A speech recognition module is further included with the voice message system for recognizing a known word from the received voice message. A substitution module is included for substituting a stored word for the known word to result in a shortened voice message. The voice message system further includes a playback module for playing the shortened voice message. In some embodiments, the substitution module operates to determine whether the known word has a voice file stored for it. If the known word does not have a voice file stored for it, then the substitution module may store audio data corresponding to a portion of the received message as the voice file for the known word. In some embodiments, the voice message system includes a playback module that produces an audible indicator to mark when the stored word is played in place of the known word in the revised voice message. The substitution module may further be for replacing the stored word in the shortened voice message with the known word in response to a user input. The voice message system, in some embodiments, further includes an evaluator module for determining a degree to which substituting the stored word for the known word makes the revised voice message shorter than the received voice message.

In the following description, for the purposes of explanation, numerous specific details are set forth in order to provide a thorough understanding of the disclosed embodiments. A person of ordinary skill in the art should recognize that embodiments might be practiced without some of these specific details. In other instances, well-known structures and devices may be shown in block diagram form or omitted for clarity.

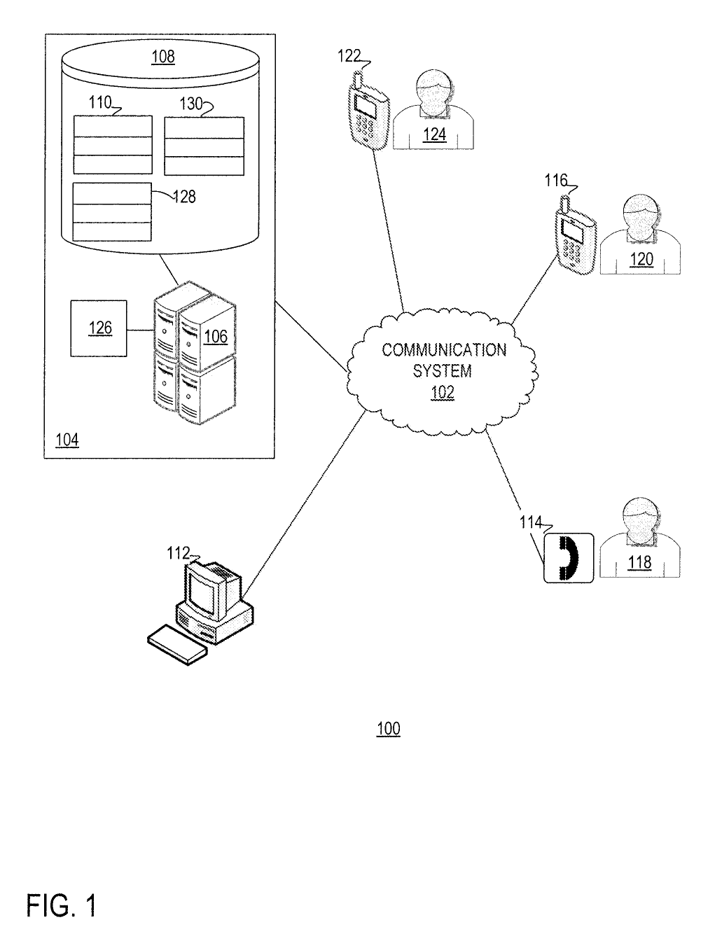

Referring to FIG. 1, an environment 100 is shown in which disclosed embodiments operate to provide voice message processing. In operation, a first caller 120 may use mobile telephone 116 to place a telephone call over communications system 102 to a user 118. If user 118 does not answer telephone 114, application server 106 may prompt caller 120 to leave a voice message for user 118. As shown, application server 106 is communicatively coupled to storage 108 which accesses a data file 128 associated with caller 120. If data file 128 is not available upon caller 120 leaving the voice message, then application server 106 may create the data file 128. Data file 128 may be indexed by caller identification information associated with mobile telephone 116. In addition, data file 128 may contain any voiceprint data compiled during calls made or during messages left by caller 120. As shown, storage 108 also accesses and maintains a data file 110 for a second caller 124 that may use mobile telephone 122 to leave messages using communication system 102 for user 118. Data file 110 stores words and associated audio files for the words that may be harvested by application server 106 during voice message processing in accordance with disclosed embodiments. Over time, as caller 124 leaves more voice messages for user 118, application server 106 employs speech recognition on the voice messages and compares recognized words to known words that may be stored in data file 128. Application server 106 evaluates received voice messages and endeavors to replace phrases or individual words in a received message to form a revised message that is shorter than the original, received message. The revised message may be stored in storage 108. In addition, the received message may be saved in storage 108. Processing of received messages by application server 106 may occur in real-time while a caller leaves a message or may occur off-line in between the time that the caller leaves the message and user 118 accesses the message. In this way, embodied systems may share processor time with other data processing systems that are otherwise engaged during the recording and initial processing of a new voice message. Off-line processing may also allow for thorough, iterative processing that produces more accurate results. In addition, the identification of callers may be accomplished offline or after a message is left to allow for application server 106 to more accurately attribute a voice message to a caller.

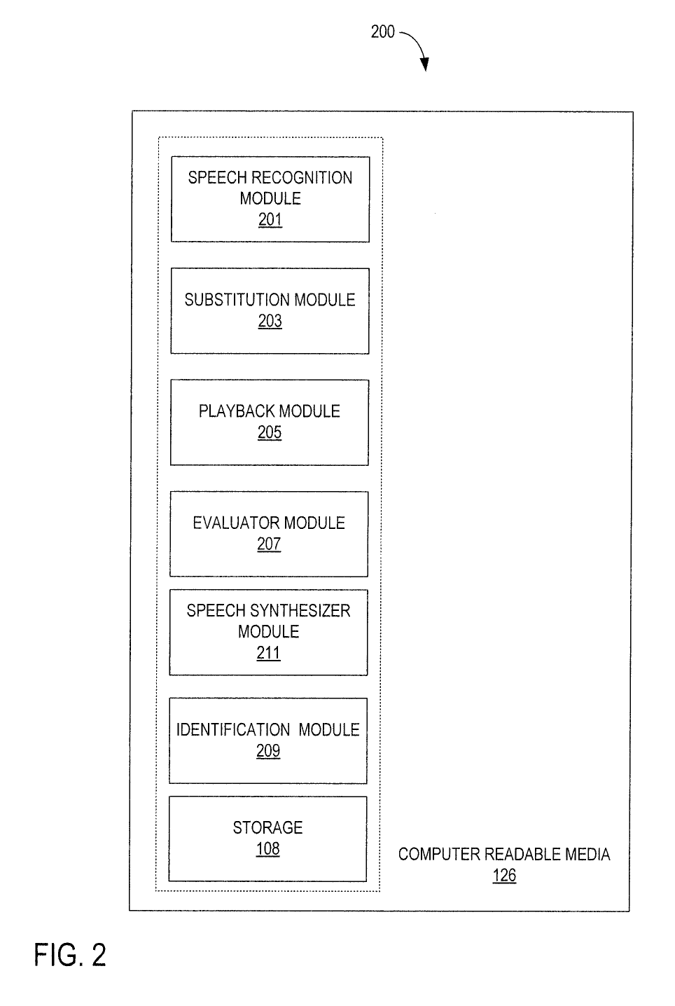

Accordingly, as shown in FIG. 1, data files that contain voiceprint data and caller ID information for callers may be stored. In addition, known words and associated audio files that are attributed to a caller may also be stored within a caller's associated data file. Using this stored data, application server 106 may then receive and process voice messages to result in shorter voice messages for user 118. In some embodiments, user 118 may set customized preferences that may be stored, for example, in data file 130. For example, user 118 may log onto application server 106 using data processing system 112 through communication system 102 or through the Internet, for example, to adjust stored words, known words, and other preferences that may be stored in data file 130 for user 118. In similar and reciprocal fashion, data file 130 may contain stored words and audio files that are used by application server 106 to shorten messages that user 118 leaves for callers 120 and 124. As shown, application server 106 is communicatively coupled to computer readable media 126 which may have stored within it computer executable instructions for accomplishing all or some of the voice processing operations accomplished by voice message system 104. For example, computer readable media 126 may have instructions that enable application server 106 to perform as a speech recognition module, a substitution module, a playback module, speech synthesizer module, an identification module, and an evaluator module as discussed in relation to FIG. 2.

Referring to FIG. 2, a voice message system 200 is disclosed that is stored on computer readable media 126 as shown. Computer readable media 126 in FIG. 2 may be identical to or similar to computer readable media 126 from FIG. 1. As shown, voice message system 200 is embodied in software modules 201-209; however, other embodied systems may include discrete hardware, firmware, or software components that are separate from application server 106 (FIG. 1). As shown, voice message system 200 includes identification module 209 for identifying a caller that leaves a voice message. In some embodiments, the caller is prompted by voice message system 200 to begin speaking the message, and the caller's speech output is recorded to result in a received voice message. In accordance with disclosed embodiments, voice message system 200 processes the received voice message and substitutes, or in some cases truncates, parts of the received voice message to result in an altered or revised voice message that is shorter than the received voice message. To this end, speech recognition module 201 is for recognizing a known word (or words) from the received voice message. Substitution module 203 is for substituting a stored word for the known word to result in a shortened voice message. Playback module 205 is for playing the shortened voice message. Stored words and shortened voice messages may be stored within storage 108. Speech synthesizer module 211 may provide synthesized versions of replacement words when relevant audio files are not available in a caller's natural voice. Playback module 205 may produce an audible indicator to mark when the stored word is played in place of the known word in the revised voice message. Some embodiments of voice message system 200, as shown in FIG. 2, employ evaluator module 207 for determining a degree to which substituting a stored word for a recognized, known word makes the revised voice message shorter than the received voice message. Evaluator module 207 may work collaboratively with substitution module 203 to determine whether any proposed word substitutions save time. In addition, evaluator module 207 may monitor user feedback, in the event a user requests to hear the original, substituted word during the playback of a revised message, to determine whether a word or phrase substitution was well received. In this way, voice message system 200 can adapt to better provide a user with enhanced message play back sessions that save time.

In some embodiments, substitution module 203 is further enabled for determining whether the known word has a voice file stored for it. If the known word does not have a voice file stored for it, then substitution module 203 or another module may store audio data for the known word. If substitution module 203, during future message processing, deems the stored audio data to be preferable over a recognized word in a future received message, the stored audio data may then be used to produce a shorter revised message. In this way, as voice message system 200 continues to operate over time as callers leave multiple voice messages, the system builds a database of stored words with associated audio files that are used to make long messages shorter. This can save time for a user of voice message system 200.

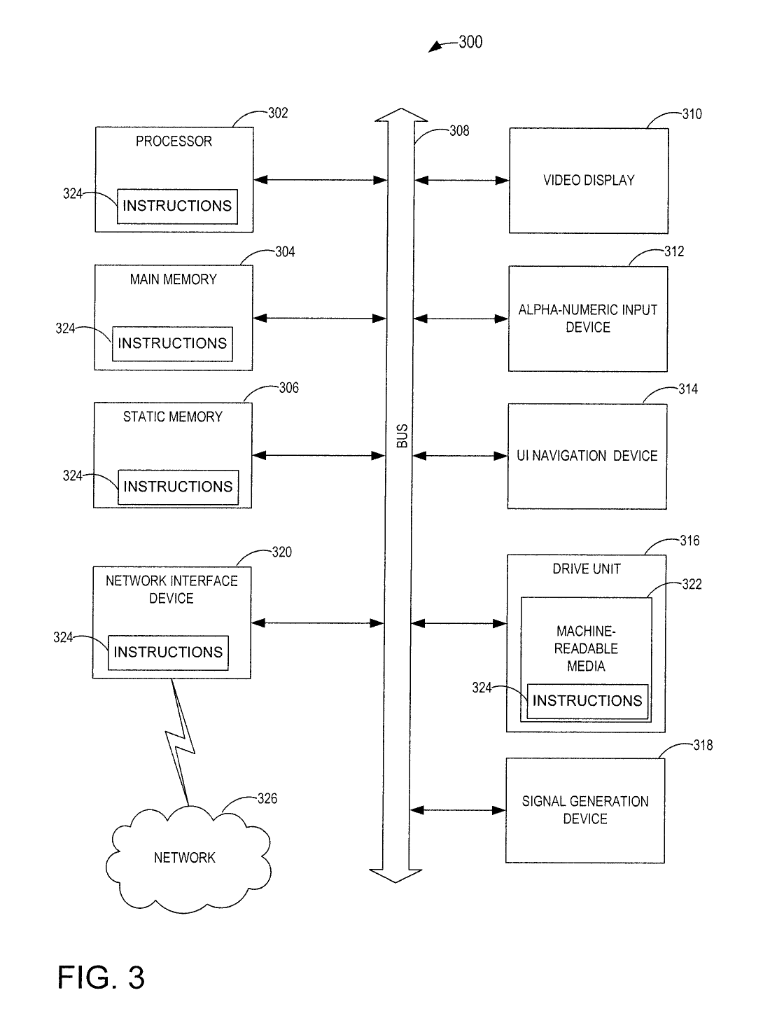

FIG. 3 illustrates in block diagram form a data processing system 300 within which a set of instructions may operate to perform one or more disclosed methodologies. Data processing system 300 may operate as a standalone device or may be connected (e.g., networked) to other data processing systems. In a networked deployment, data processing system 300 may operate in the capacity of a server or a client data processing system in a server-client network environment, or as a peer computer in a peer-to-peer (or distributed) network environment. Example data processing systems include, but are not limited to a personal computer (PC), a local answering machine, a network-based application server hosting a voice message processing system, a tablet PC, telephone, a smart phone, a web appliance, a network router, a switch, a bridge, a server, or any machine capable of executing a set of instructions (sequential or otherwise) that specify actions to be taken by that machine. Further, although FIG. 3 illustrates only one data processing system, the term “data processing system” shall also be taken to include any collection of data processing systems that individually or jointly execute a set (or multiple sets) of instructions to perform any one or more of the methodologies discussed herein.

As shown, data processing system 300 includes a processor 302 (e.g., a central processing unit, a graphics processing unit, or both), a main memory 304, and a static memory 306 that may communicate with each other via a bus 308. In some embodiments, the main memory 304 and/or the static memory 306 may be used to store the indicators or values that relate to multimedia content accessed or requested by a consumer. Data processing system 300 may further include a video display unit 310 (e.g., a liquid crystal display (LCD)) on which to display information related to voice messages such as caller identification information and the like. Video display unit 310 may also be used to display and edit which words are associated for callers, to allow a user to make adjustments. In addition, using data processing system 300 and video display unit 310, a user may manually enter domain specific (e.g., telecommunications specific) acronyms and words that are stored for access during automatic message processing.

As shown, data processing system 300 also includes an alphanumeric input device 312 (e.g., a keyboard or a remote control), a user interface (UT) navigation device 314 (e.g., a remote control or a mouse), a disk drive unit 316, a signal generation device 318 (e.g., a speaker) and a network interface device 320. The input device 312 and/or the UT navigation device 314 (e.g., the remote control) may include a processor (not shown), and a memory (not shown). The disk drive unit 316 includes a machine-readable medium 322 that may have stored thereon one or more sets of instructions and data structures (e.g., instructions 324) embodying or utilized by any one or more of the methodologies or functions described herein. The instructions 324 may also reside, completely or at least partially, within the main memory 304, within static memory 306, within network interface device 320, and/or within the processor 302 during execution thereof by the data processing system 300.

The instructions 324 may further be transmitted or received over a network 326 (e.g., a telephone network or voice over Internet protocol network) via the network interface device 320 utilizing any of a number of transfer protocols (e.g., Hypertext Transfer Protocol). While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine (i.e., data processing system) and that cause the machine to perform any one or more of the methodologies of the present disclosure, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

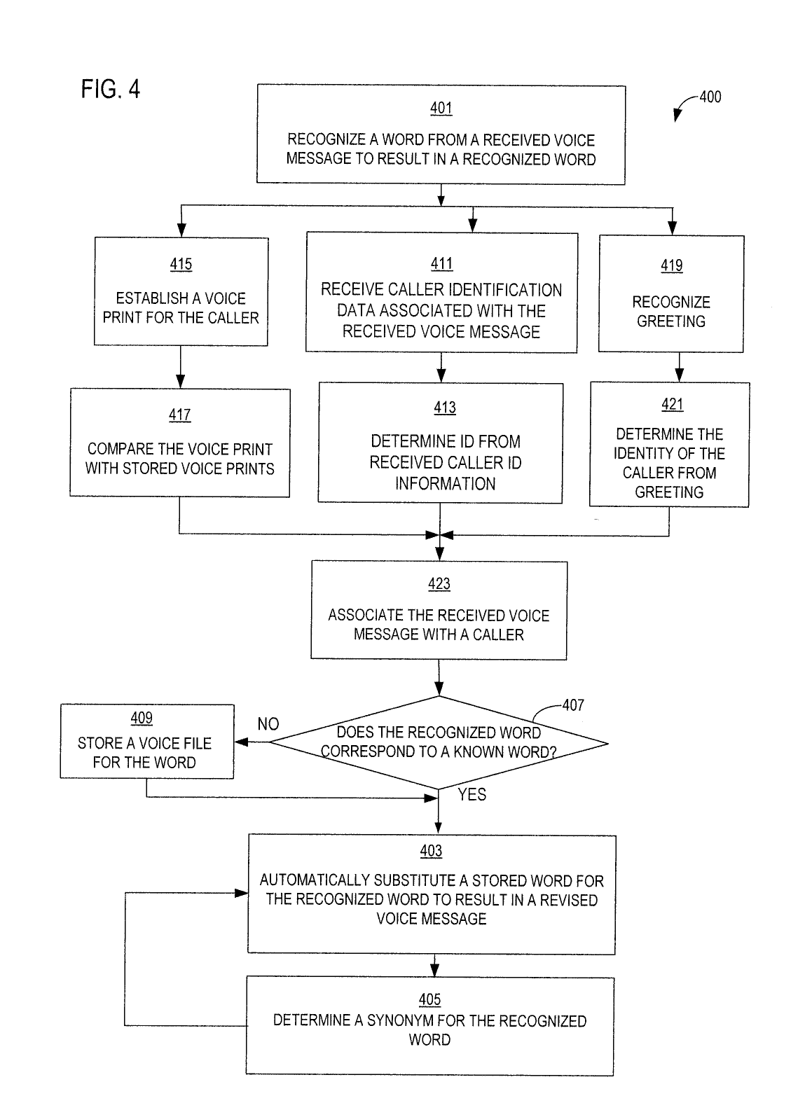

FIG. 4 illustrates a methodology 400 with selected operations for processing voice messages in accordance with disclosed embodiments. Methodology 400 may be carried out by one or more data processing systems, for example data processing system 300 (FIG. 3). In such cases, a data processing system or a network of data processing systems may have one or more computer readable media with instructions that enable carrying out methodology 400.

Technologies related to recording and accessing voice messages (i.e., voice mails) are common. If a caller makes a telephone call that is unanswered, embodied systems may provide an opportunity for the caller to leave a voice message that is processed to reduce the time required to listen to the voice message. Accordingly, operation 401 relates to recognizing a word from the received voice message to result in a recognized word. Operation 401 may be conducted by a speech recognition module (e.g., speech recognition module 201 in FIG. 2) or other subroutine and may as result in more than one recognized word. In addition, operation 401 may result in a recognized phrase rather than just a single, recognized word. For example, a received voice message may be processed to yield the following text: “Hello, this is John, I am just calling to tell you that I am home now so call me when you get this message.” In some embodiments, stored words, recognized words, voice messages, and the like are stored on a per-caller basis. If an embodied system has stored audio files associated with recognized words that are shorter than the recognized words, then the embodied systems may create a revised message with the stored audio files (i.e., the stored words) used to replace the recognized words. In order to operate on a per-caller basis, embodied systems may rely on operations 411-421 in some combination to determine the identity of a caller. For example, operations 415 and 417 relate to using a voice print developed for a caller to determine the identity of the caller. When callers leave a voice message, voice prints may be stored that relate to voice frequency, speech patterns, word choices, and any other identifying characteristics of the caller's voice. Accordingly, stored audio files having substitute words may be indexed in a data file according to the voice print. When any caller leaves a new voice message, the voice message may be analyzed in operation 415 to determine a voice print for the new caller. Operation 417 relates to comparing the newly created voice print to stored voice prints. If a match is found, the identity of the caller may be known.

As shown in FIG. 4, means for identifying a caller relate to using caller identification information received at the time a voice message is received to help identify a caller. To this end, operation 411 relates to receiving caller identification data associated with a received voice message. Operation 413 relates to determining the identity of the caller from the received caller identification information. Many standard telephone systems use caller identification information to transmit the name of a caller, the telephone number, and other information related to a call. In some cases, caller identification information may apply to more than one caller, for example in a situation where a family of four uses one land based line. In such cases, operations 411 and 413 may be used in conjunction with operations 415 and 417 to determine the identity of a caller for accessing and storing information that is organized on a per-caller basis. Alternatively or in addition, recognized words may be used to determine the identity of a caller. For example, if a speech recognition module recognizes the text, “Hey this is John Doe,” in a recorded voice message, an embodied system that carries out operation 419 may recognize these words as possibly containing indications related to the identification of the caller. In operation 421, a determination is made whether the recognized words (e.g., “John Doe”) can be determined to be an indication of the caller. For example, caller ID information from past calls may be compared to caller ID received in association with the current, received message. In addition, a voice print that is established for John Doe may be compared to a voice print established during the current, received message. Accordingly, the identification of a caller that leaves a received message may be established using, for example, some combination of operation 411-421.

As shown, in operation 423 disclosed embodiments may associate the received voice message with a particular caller. In operation 407, if the recognized word corresponds to a known word, embodied systems continue to operation 403 which relates to automatically substituting a stored word for the recognized word to result in a revised voice message. If in operation 407 the recognized word does not correspond to a known word, operation 409 relates to storing a voice file for the word. For example, in systems that operate on a per-caller basis, when a first message is received for a particular caller, there may be no stored words associated for the caller. So, the message, “I am just calling to tell you that I am home now so call me when you get this message” may contain one or more words (or phrases) that result in audio files being stored in operation 409. For example, the text “I am” may be stored as an audio file, as it can be later used to replace other more verbose phrases such as “I am just calling to tell you that I am.” In addition, “message” may be stored, because it is a common word and it has two syllables. The word “message,” having two syllables, makes it a candidate for replacement by monosyllabic words (e.g., “note” ) and makes it a candidate for replacing other words (e.g., “memorandum”) with three or more syllables. In embodied systems, a database of synonyms (e.g., memorandum, note, and message) may be maintained and accessed for use in making revised messages that are shorter than received messages.

In the above example, “I am just calling to tell you that I am may be a recognized “word” as produced in operation 401. A user of an embodied system may deem this recognized word as unnecessarily long, and the user may wish to reduce such words or phrases from played messages. Accordingly, operation 403 relates to automatically substituting a word for the recognized word to result in a revised voice message. In this case, the word “I'm” may be the stored word that replaces the recognized words “I am just calling to tell you that I am.” Similarly, the words “call me” may be substituted for “call me when you get this message.” In such a case, “call me” is the stored word and “call me when you get this message” are the recognized words. Again, the term “word” is meant, in embodiments described and disclosed herein, to include “word or words” and not be limited to the singular form “word.”

As shown in FIG. 4, operation 405 relates to determining a synonym for the recognized word. In another example, a received voice message may contain the following recognized text: “Hey Jim, we should take our children to the playground.” In operation 405, the term “children” may be a recognized word as determined in operation 401. Accordingly, in operation 403, the term “children” may be substituted by the term “kids” in a revised voice message, if in operation 405 the term “kids” is determined to be a synonym for “children.” In some instances, selecting a stored word for substitution is an iterative process with operation 405. Therefore, synonyms for use in replacing recognized words may be iteratively selected and the resulting phrase or sentence may be checked against grammar and syntax rules to determine how appropriate the substitution is.

Therefore, in accordance with disclosed embodiments, audio files that are associated with recognized words may be accessed and played within revised messages. In some cases, a caller's original words, possibly from other received messages, are used in producing parts of a revised message. In other cases, embodied systems may synthesize speech to replace rather verbose phrases that are commonly left with recorded voice messages. Some embodiments play audible indications (e.g., a beep) at the beginning of the portion of a revised message that contains a substituted word or phrase. Alternatively, the play speed of a message may be increased or the replacement words and phrases may be audibly skewed to indicate that they are replacement words or phrases. If a user hears the audible indicators and wants to listen to the original phrase or words recorded by the caller, the user may provide input to result in a replay of at least the portion of the message that contains the substituted text in the revised message.

While the disclosed systems may be described in connection with one or more embodiments, it is not intended to limit the subject matter of the claims to the particular forms set forth. On the contrary, it is intended to cover such alternatives, modifications and equivalents as may be included within the spirit and scope of the subject matter as defined by the appended claims.

What is claimed is:

1. A method of processing received voice messages, the method comprising:
recognizing a word from a received voice message to result in a recognized word; and
substituting a stored word for the recognized word to result in a revised voice message.

2. The method of claim 1 further comprising:
determining a synonym for the recognized word, wherein the synonym is the stored word for substituting for the recognized word, and further wherein the duration of the revised voice message is shorter than the duration of the received voice message.

3. The method of claim 2 further comprising:
comparing the recognized word to a plurality of known words; and
if the recognized word corresponds to a known word, storing a voice file for the recognized word.

4. The method of claim 3 further comprising:
associating the received voice message with a caller, wherein the stored voice file for the recognized word is associated with the caller.

5. The method of claim 4, further comprising:
establishing a voice print for the caller; and
comparing the voice print of the caller with stored voice prints to determine an identity of the caller.

6. The method of claim 4, further comprising:
receiving caller identification data associated with the received voice message; and
determining an identity of the caller based on the received caller identification data.

7. The method of claim 4, further comprising:
performing voice recognition on a greeting within the received voice message to result in a recognized greeting; and
using the recognized greeting in determining the identity of the caller.

8. A computer program product stored on one or more computer readable media, the computer program product having instructions operable for:
recognizing a word from a received voice message to result in a recognized word; and
substituting a stored word for the recognized word to result in a revised voice message.

9. The computer program product of claim 8, further having instructions operable for:
building the revised voice message by inserting a stored sound file in place of the recognized word, wherein the stored sound file is associated with the stored word.

10. The computer program product of claim 9, further having instructions operable for:
playing the revised voice message.

11. The computer program product of claim 10, further having instructions operable for:
providing an audible signal to indicate when the stored sound file is played within the revised voice message.

12. The computer program product of claim 10, further having instructions operable for:
repeating a portion of the revised message in response to a user input to result in a repeated portion, and wherein the repeated portion contains the recognized word in place of the stored sound file.

13. The computer program product of claim 12, further having instructions operable for:
determining a synonym for the recognized word, wherein the synonym is the stored word for substituting for the recognized word, and further wherein the duration of the revised voice message with the synonym is shorter than the duration of the received voice message.

14. The computer program product of claim 13, further comprising:
evaluating whether the revised voice message is shorter than the received voice message.

15. The computer program product of claim 8 further having instructions operable for:
comparing the recognized word to a plurality of known words; and
if the recognized word corresponds to a known word, storing a voice file for the recognized word.

16. The computer program product of claim 15 further having instructions operable for:
associating the received voice message with a caller, wherein the stored voice file for the recognized word is associated with the caller.

17. The computer program product of claim 16, further comprising:
establishing a voice print for the caller; and
comparing the voice print of the caller with stored voice prints to determine an identity of the caller.

18. A voice message system comprising:
an identification module for identifying a caller, wherein the caller produces speech output to result in a received voice message;
a speech recognition module for recognizing a known word from the received voice message;
a substitution module for substituting a stored word for the known word to result in a shortened voice message; and
a playback module for playing the shortened voice message.

19. The voice message system of claim 18, the voice message system further comprising:
an evaluator module for determining a degree to which substituting the stored word for the known word makes the revised voice message shorter than the received voice message.

20. The voice message system of claim 18, wherein the substitution module is further for:
determining whether the known word has a voice file stored for it; and
if the known word does not have a voice file stored for it, then:
storing audio data corresponding to a portion of the received message as the voice file for the known word.

21. The voice message system of claim 18, wherein the playback module further produces an audible indicator to mark when the stored word is played in place of the known word.

22. The voice message system of claim 21, wherein the substitution module is further for replacing the stored word in the shortened voice message with the known word in response to a user input.
